(19) United States
(12) Patent Application Publication
(10) Pub. No.: US 2013/0216801 A1
(43) Pub. Date: Aug. 22, 2013

(54) Transparent Thin-Wall Scratch-Resistant Article

(71) Applicant: SABIC INNOVATIVE PLASTICS IP B.V., (US)

(72) Inventors: Takeshi Kadoki, Soka-city (JP); Mohd Shamsul Hairi bin Mohd Salleh, Tochigi (JP); Jian Yang, Shanghai (CN); Robert Dirk van de Grampel, Tholen (NL)

(73) Assignee: SABIC INNOVATIVE PLASTICS IP B.V., Bergen op Zoom (NL)

(21) Appl. No.: 13/767,454

(22) Filed: Feb. 14, 2013

(30) Foreign Application Priority Data
Feb. 17, 2012 (CN) PCT/CN2012/071255
Feb. 20, 2012 (CN) PCT/CN2012/071330

(51) Int. Cl. C08L 69/00

(52) U.S. Cl. CPC C08L 69/00
USPC 428/215; 428/337; 427/164; 427/558

(57) ABSTRACT

A plastic article is described having a substrate of a substantially transparent substrate having a thickness of from 0.2 mm to 3.0 mm, and including a thermoplastic composition comprising a polycarbonate and having a melt flow index as defined by ASTM D1238 of 10 g/10 min. to 50 g/10 min. at 300° C. and a 1.2 kg load, the thermoplastic composition including a polycarbonate, the thermoplastic composition comprising 20 mol % to 80 mol % of specified cyclohexylidene-bridged carbonate units and 80 mol % to 20 mol % of specified other carbonate units. The substrate has a hard coat thereon that provides the article with a pencil hardness of at least 5H as determined according to JIS K5400 using a 0.75 kgf load.

### BACKGROUND OF THE INVENTION

This disclosure relates to polycarbonate articles, and in particular to transparent, thin-wall, scratch-resistant articles based on polycarbonate compositions, as well as methods of their manufacture.

Polycarbonates are useful in the manufacture of articles and components for a wide range of applications, from automotive parts to electronic appliances. Because of their broad use, particularly in electronic applications such as mobile phone, portable media player, or other electronic device screens, it is desirable to provide polycarbonates with physical properties such as high levels of hardness, scratch and mar resistance, and impact resistance, combined with optical properties such as high light transmittance, low haze, and low yellowness. Although many polycarbonate compositions can provide beneficial combinations of the aforementioned properties, many known compositions have not been able to achieve superior levels in hardness or scratch and mar resistance or other properties for use in demanding thin wall applications such as display screen windows for mobile smart phones and portable media players and gaming devices, compared to the best potassium-infused alkali-aluminosilicate sheet glasses currently used in such applications. However, thermoplastic materials such as polycarbonates can offer a number of other advantages over alkali-aluminosilicate glass, such as ease of molding into net shape or near net shape articles, improved impact resistance and flexibility, more efficient manufacturing, and lower weight.

WO 2007/008390 A1 discloses coated dimethylbisphenolcyclohexane (DMBPC)-based polycarbonate materials for use as a glass replacement. However, the highest levels of hardness reported therein reaches only a pencil hardness of 4H, which is lower than the best alkali-aluminosilicate glass materials, and it requires a high level (90%) of DMBPC in the polycarbonate polymer to achieve such a hardness level.

There accordingly remains a need in the art for polycarbonate-based thermoplastic materials that can achieve the combination of physical and optical properties to serve as a replacement for alkali-aluminosilicate glass materials, such as those used in portable electronic devices.

### SUMMARY OF THE INVENTION

In an embodiment, the above-described and other deficiencies of the art are addressed by a plastic article comprising

a substantially transparent substrate having a thickness of from 0.2 mm to 3.0 mm, and comprising a thermoplastic composition comprising a polycarbonate and having a melt flow index as defined by ASTM D1238 of 10 g/10 min. to 50 g/10 min. at 300° C. and a 1.2 kg load, the thermoplastic composition comprising 20 mol % to 80 mol % of carbonate units represented by the formula (I)

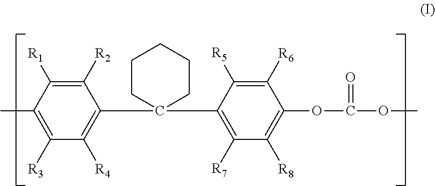

wherein R₁, R₂, R₃, R₄, R₅, R₆, R₇, and R₈ each independently represents hydrogen or C₁₋₆ alkyl, and 80 mol % to 20 mol % a carbonate unit, represented by the formula (II)

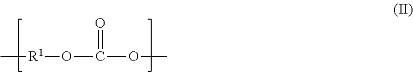

wherein at least 60 percent of the total number of R¹ groups contain aromatic moieties and the balance thereof are aliphatic, alicyclic, or aromatic, wherein the mol % values are based on the total number of carbonate units in the polymer composition; and

a hard coat disposed over a surface of the transparent sheet, the hard coat providing the article with a pencil hardness of at least 5H as determined according to JIS K5400 using a 0.75 kgf load.

In another embodiment, a method of making an article comprises

injection molding a thermoplastic composition to form a substantially transparent sheet having a thickness of from 0.2 mm to 1.5 mm, the thermoplastic composition comprising a polycarbonate and having a melt flow index as defined by ASTM D1238 of 10 g/10 min. to 50 g/10 min. at 300° C. and a 1.2 kg load, the thermoplastic composition comprising 20 mol % to 80 mol % of carbonate units represented by the formula (I)

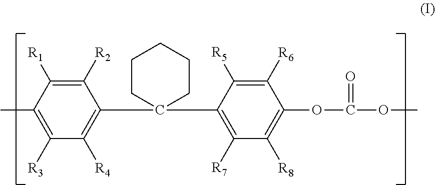

wherein R₁, R₂, R₃, R₄, R₅, R₆, R₇, and R₈ each independently represents hydrogen or C₁₋₆ alkyl, and 80 mol % to 20 mol % of a carbonate unit, represented by the formula (II)

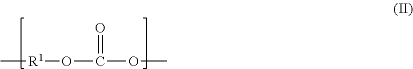

wherein at least 60 percent of the total number of R¹ groups contain aromatic moieties and the balance thereof are aliphatic, alicyclic, or aromatic, wherein the mol % values are based on the total number of carbonate units in the polymer composition;

applying a layer of a hard-coat coating composition to a surface of the transparent sheet; and

curing the coating composition to form a hard coat that provides the article with a pencil hardness of at least 5H as determined according to JIS K5400 using a 0.75 kgf load.

The above described and other features are further disclosed and exemplified by the following detailed description.

### DETAILED DESCRIPTION OF THE INVENTION

Surprisingly, it has been discovered that the above-described article comprising a substrate of a thermoplastic composition having a MFI of 10-50 grams per 10 minutes (g/10 min.) at 300° C. and a 1.2 kilogram (kg) load, and comprising a polycarbonate having 20 to 80 mole percent (mol. %) of carbonate units of formula (I) and 80 to 20 mol. % of carbonate units of formula (II), plus a hard coat that imparts a pencil hardness of at least 5H can be readily manufactured by efficient techniques such as injection molding into thin-wall articles having a thickness of 0.2 millimeter (mm) to 3.0, while providing excellent scratch, mar, and impact resistance along with excellent optical properties of light transmittance and low haze and yellowness. As mentioned above, in an exemplary embodiment, the substrate has a thickness of 0.2 mm to 3.0 mm. In another exemplary embodiment, the substrate has a thickness of 0.2 mm to 1.5 mm. In yet another exemplary embodiment, the substrate has a thickness of 0.3 mm to 2.0 mm. In still another exemplary embodiment, the substrate has a thickness of 0.5 mm to 1.5 mm. In a further exemplary embodiment, the substrate has a thickness of 0.5 mm to 1.0 mm.

The specified mol. % values for the units of formulas (I) and (II) in the thermoplastic composition can be provided by a single co-polymer comprising carbonate units of formulas (I) and (II) or by a blend of polymers or co-polymers, one or more of which comprises carbonate units of formula (I) and one or more of which comprises carbonate units of formula (II). In an exemplary embodiment, the thermoplastic composition comprises from 20 to 80 mol. % of carbonate units of formula (I) and 80 to 20 mol. % of carbonate units of formula (II). In another exemplary embodiment, the thermoplastic composition comprises from 30 to 80 mol. % of carbonate units of formula (I) and 70 to 20 mol. % of carbonate units of formula (II). In yet another exemplary embodiment, the thermoplastic composition comprises from 40 to 80 mol. % of carbonate units of formula (I) and 60 to 20 mol. % of carbonate units of formula (II). In still another exemplary embodiment, the thermoplastic composition comprises from 50 to 80 mol. % of carbonate units of formula (I) and 50 to 20 mol. % of carbonate units of formula (II). In a further exemplary embodiment, the thermoplastic composition comprises from 30 to 70 mol. % of carbonate units of formula (I) and 70 to 30 mol. % of carbonate units of formula (II). In another further exemplary embodiment, the thermoplastic composition comprises from 40 to 60 mol. % of carbonate units of formula (I) and 60 to 40 mol. % of carbonate units of formula (II).

The polycarbonate(s) comprising the units of formulas (I) and/or (II) can be linear or branched, as described in further detail below. The carbonate units of formula (I) are derived from aromatic diols such as dimethylbisphenolcyclohexane, 4,4′-cyclohexylidene bisphenol (bisphenol Z) and other compounds readily identifiable within the scope of formula (I). The carbonate units of formula (II) are derived from a wide variety of diol compounds, as described in further below.

As used herein, the term “polycarbonate” means compositions having repeating structural carbonate units of formula (1)

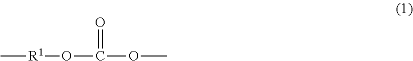

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from a dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (3)

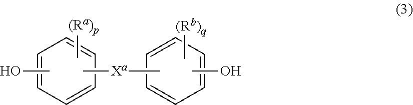

wherein R^{a} and R^{b} are each independently a halogen or C₁₋₁₂ alkyl group; and p and q are each independently integers of 0 to 4. It will be understood that R^{a} is hydrogen when p is 0, and likewise R^{b} is hydrogen when q is 0. Also in formula (3), X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In an embodiment, p and q is each 1, and R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. A specific example wherein X^{a} is a substituted cycloalkylidene is the cyclohexylidene-bridged, alkyl-substituted bisphenol of formula (4)

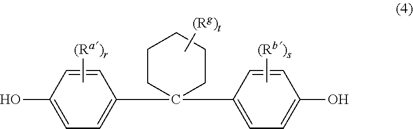

wherein R^{a′} and R^{b′} are each independently C₁₋₁₂ alkyl, R^{g} is C₁₋₁₂ alkyl or halogen, r and s are each independently 1 to 4, and t is 0 to 10. In a specific embodiment, at least one of each of R^{a′} and R^{b′} are disposed meta to the cyclohexylidene bridging group. The substituents R^{a′}, R^{b′}, and R^{g} can, when comprising an appropriate number of carbon atoms, be straight chain, cyclic, bicyclic, branched, saturated, or unsaturated. In an embodiment, R^{a′} and R^{b′} are each independently C₁₋₄ alkyl, R^{g} is C₁₋₄ alkyl, r and s are each 1, and t is 0 to 5. In another specific embodiment, R^{a′}, R^{b′} and R^{g} are each methyl, r and s are each 1, and t is 0 or 3. The cyclohexylidene-bridged bisphenol can be the reaction product of two moles of o-cresol with one mole of cyclohexanone. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures.

In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

X^{a} can also be a substituted C₃₋₁₈ cycloalkylidene of formula (5)

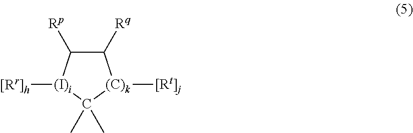

wherein R^{r}, R^{p}, R^{q}, and R^{t} are each independently hydrogen, halogen, oxygen, or C₁₋₁₂ organic groups; I is a direct bond, a carbon, or a divalent oxygen, sulfur, or —N(Z)— where Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When k is one and i is 0, the ring as shown in formula (5) contains 4 carbon atoms, when k is 2, the ring as shown in formula (5) contains 5 carbon atoms, and when k is 3, the ring contains 6 carbon atoms. In an embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

Other useful aromatic dihydroxy compounds of the formula HO—R¹—OH include compounds of formula (6)

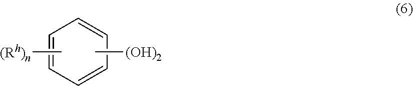

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl)methane, 1,1-bis(4-hydroxyphenyl)ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-2-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

The polycarbonates can have an intrinsic viscosity, as determined in chloroform at 25° C., of about 0.3 to about 1.5 deciliters per gram (dl/gm), specifically about 0.45 to about 1.0 dl/gm. The polycarbonates can have a weight average molecular weight of about 10,000 to about 200,000 Daltons, specifically about 20,000 to about 100,000 Daltons, as measured by gel permeation chromatography (GPC), using a crosslinked styrene-divinylbenzene column and calibrated to polycarbonate references. GPC samples are prepared at a concentration of about 1 milligram (mg) per milliliter (ml), and are eluted at a flow rate of about 1.5 ml per minute.

In an embodiment, the thermoplastic composition has flow properties useful for the manufacture of thin articles. Melt flow index (also referred to as melt flow rate and abbreviated as MFI or MFR) measures the rate of extrusion of a thermoplastic through an orifice at a prescribed temperature and load. Compositions useful for the formation of thin articles can have an MFI, measured at 300° C. under a load of 1.2 kg, of about 10 to about 50 g per 10 minutes (g/10 min), specifically about 14 grams (g) to about 50 g/10 min, and more specifically about 20 g to about 50 g/10 min. Combinations of polycarbonates of different flow properties can be used to achieve the overall desired flow property.

“Polycarbonates” as used herein further include homopolycarbonates (wherein each R¹ in the polymer is the same), copolymers comprising different R¹ moieties in the carbonate (referred to herein as “copolycarbonates”), copolymers comprising carbonate units and other types of polymer units, such as ester units or siloxane units, and combinations comprising at least one of homopolycarbonates and/or copolycarbonates. As used herein, a “combination” is inclusive of blends, mixtures, alloys, reaction products, and the like.

Polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as triethylamine and/or a phase transfer catalyst, under controlled pH conditions, e.g., about 8 to about 12. The most commonly used water immiscible solvents include methylene chloride, 1,2-dichloroethane, chlorobenzene, toluene, and the like.

Exemplary carbonate precursors include a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

Among the phase transfer catalysts that can be used are catalysts of the formula (R^{u})₄Q⁺X, wherein each R^{u} is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 weight percent (wt %) based on the weight of bisphenol in the phosgenation mixture. In another embodiment an effective amount of phase transfer catalyst can be about 0.5 to about 2 wt % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

A chain stopper (also referred to as a capping agent) can be included during polymerization. The chain stopper limits molecular weight growth rate, and so controls molecular weight in the polycarbonate. Exemplary chain stoppers include certain mono-phenolic compounds, mono-carboxylic acid chlorides, and/or mono-chloroformates. Mono-phenolic chain stoppers are exemplified by monocyclic phenols such as phenol and C₁-C₂₂ alkyl-substituted phenols such as p-cumyl-phenol, resorcinol monobenzoate, and p- and tertiary-butyl phenol; and monoethers of diphenols, such as p-methoxyphenol. Alkyl-substituted phenols with branched chain alkyl substituents having 8 to 9 carbon atom can be specifically mentioned. Certain mono-phenolic UV absorbers can also be used as a capping agent, for example 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like.

Mono-carboxylic acid chlorides can also be used as chain stoppers. These include monocyclic, mono-carboxylic acid chlorides such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with less than or equal to about 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Alternatively, melt processes can be used to make the polycarbonates. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl) carbonate, bis(2-acetylphenyl) carboxylate, bis(4-acetylphenyl) carboxylate, or a combination comprising at least one of the foregoing esters. In addition, useful transesterification catalysts can include phase transfer catalysts of formula (R³)₄Q⁺X, wherein each R³, Q, and X are as defined above. Exemplary transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

The composition can optionally include a polyester carbonate, also known as a polyester-polycarbonate. Such copolymers further contain, in addition to recurring carbonate chain units of the formula (1), units of (7):

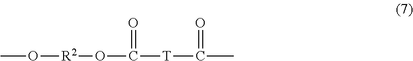

wherein R² is a divalent group derived from a dihydroxy compound, and may be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T is a divalent group derived from a dicarboxylic acid (aliphatic, aromatic, or alkyl aromatic), and may be, for example, a C₄₋₁₈ aliphatic group, a C₆₋₂₀ alkylene group, a C₆₋₂₀ alkylene group, a C₆₋₂₀ alicyclic group, a C₆₋₂₀ alkyl aromatic group, or a C₆₋₂₀ aromatic group.

R² may be is a C₂₋₃₀ alkylene group having a straight chain, branched chain, or cyclic (including polycyclic) structure. Alternatively, R² may be derived from an aromatic dihydroxy compound of formula (3) above, or from an aromatic dihydroxy compound of formula (6).

Examples of aromatic dicarboxylic acids that may be used to prepare the polyester units include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or combinations thereof. A specific dicarboxylic acid comprises a combination of isophthalic acid and terephthalic acid wherein the weight ratio of isophthalic acid to terephthalic acid is about 91:9 to about 2:98. In another specific embodiment, R² is a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers may vary broadly, for example 1:99 to 99:1, specifically 10:90 to 90:10, more specifically 25:75 to 75:25, depending on the desired properties of the final composition.

In an embodiment, the thermoplastic composition comprises a polyester-polycarbonate copolymer, and specifically a polyester-polycarbonate copolymer in which the ester units of formula (7) comprise soft block ester units, also referred to herein as aliphatic dicarboxylic acid ester units. Such a polyester-polycarbonate copolymer comprising soft block ester units is also referred to herein as a poly(aliphatic ester)-polycarbonate. The soft block ester unit can be a C₆₋₂₀ aliphatic dicarboxylic acid ester unit (where C₆₋₂₀ includes the terminal carboxyl groups), and may be straight chain (i.e., unbranched) or branched chain dicarboxylic acids, cycloalkyl or cycloalkylidene-containing dicarboxylic acids units, or combinations of these structural units. In an embodiment, the C₆₋₂₀ aliphatic dicarboxylic acid ester unit includes a straight chain alkylene group comprising methylene (—CH₂—) repeating units. In a specific embodiment, a useful soft block ester unit comprises units of formula (7a):

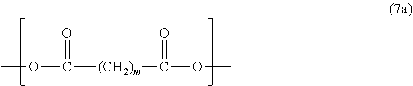

where m is 4 to 18. In a specific embodiment of formula (7a), m is 8 to 10. The poly(aliphatic ester)-polycarbonate can include less than or equal to 25 wt % of the soft block unit. In an embodiment, a poly(aliphatic ester)-polycarbonate comprises units of formula (7a) in an amount of 1 to 10 wt %, specifically 2 to 9 wt %, and more specifically 3 to 8 wt %, based on the total weight of the poly(aliphatic ester)-polycarbonate. Also in an embodiment, the soft block ester has a glass transition temperature of 128 to 139° C., specifically 130 to 139° C.

The poly(aliphatic ester)-polycarbonate is a copolymer of soft block ester units with carbonate units. The poly(aliphatic ester)-polycarbonate is shown in formula (7b)

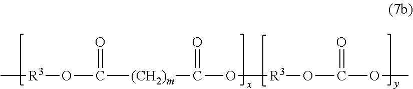

where each R³ is independently derived from a dihydroxyaromatic compound of formula (3) or (6), m is 4 to 18, and x and y each represent average weight percentages of the poly(aliphatic ester)-polycarbonate where the average weight percentage ratio x:y is 10:90 to 1:99, specifically 9:91 to 2:98, and more specifically 8:92 to 3:97, where x+y is 100.

Soft block ester units, as defined herein, can be derived from an alpha, omega C₆₋₂₀ aliphatic dicarboxylic acid or a reactive derivative thereof. In a specific embodiment, the carboxylate portion of the aliphatic ester unit of formula (7a), in which the terminal carboxylate groups are connected by a chain of repeating methylene (—CH₂—) units (where m is as defined for formula (7a)), is derived from the corresponding dicarboxylic acid or reactive derivative thereof, such as the acid halide (specifically, the acid chloride), an ester, or the like. Exemplary alpha, omega dicarboxylic acids (from which the corresponding acid chlorides may be derived) include alpha, omega C₆ dicarboxylic acids such as hexanedioic acid (also referred to as adipic acid); alpha, omega C₁₀ dicarboxylic acids such as decanedioic acid (also referred to as sebacic acid); and alpha, omega C₁₂ dicarboxylic acids such as dodecanedioic acid (sometimes abbreviated as DDDA). It will be appreciated that the aliphatic dicarboxylic acid is not limited to these exemplary carbon chain lengths, and that other chain lengths within the C₆₋₂₀ limitation may be used. A specific embodiment of the poly(aliphatic ester)-polycarbonate having soft block ester units comprising a straight chain methylene group and a bisphenol A polycarbonate group is shown in formula (7c)

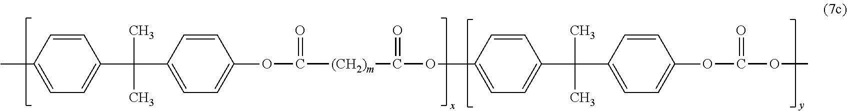

where m is 4 to 18 and x and y are as defined for formula (7b). In a specific exemplary embodiment, a useful poly(aliphatic ester)-polycarbonate copolymer comprises sebacic acid ester units and bisphenol A carbonate units (formula (7c), where m is 8, and the average weight ratio of x:y is 6:94).

The composition can optionally include a poly(siloxane-carbonate) copolymer, also referred to in the art as a polysiloxane-polycarbonate or a polydiorganosiloxane-carbonate. The poly(siloxane-carbonate) further contains diorganosiloxane (“siloxane”) units, generally in the form of blocks. The polydiorganosiloxane (“polysiloxane”) blocks of the copolymer comprise repeating siloxane units as in formula (10)

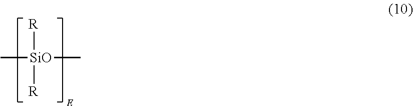

wherein each R is independently a C₁₋₁₃ monovalent organic group. For example, R can be a C₁-C₁₃ alkyl, C₁-C₁₃ alkoxy, C₂-C₁₃ alkenyl group, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ aralkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The value of E in formula (10) can vary widely depending on the type and relative amount of each component in the thermoplastic composition, the desired properties of the composition, and like considerations. Generally, E has an average value of 2 to about 1,000, specifically about 2 to about 500, more specifically about 5 to about 100. In an embodiment, E has an average value of about 10 to about 75, and in still another embodiment, E has an average value of about 40 to about 60. Where E is of a lower value, e.g., less than about 40, it can be desirable to use a relatively larger amount of the polycarbonate-polysiloxane copolymer. Conversely, where E is of a higher value, e.g., greater than about 40, a relatively lower amount of the polycarbonate-polysiloxane copolymer can be used.

A combination of a first and a second (or more) polycarbonate-polysiloxane copolymers can be used, wherein the average value of E of the first copolymer is less than the average value of E of the second copolymer.

In an embodiment, the polysiloxane blocks are of formula (11)

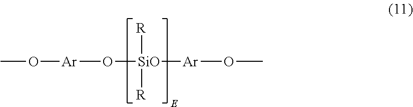

wherein E is as defined above; each R can be the same or different, and is as defined above; and Ar can be the same or different, and is a substituted or unsubstituted C₆-C₃₀ arylene group, wherein the bonds are directly connected to an aromatic moiety. Ar groups in formula (11) can be derived from a C₆-C₃₀ dihydroxyarylene compound, for example a dihydroxyarylene compound of formula (3) or (6) above. Exemplary dihydroxyarylene compounds are 1,1-bis(4-hydroxyphenyl)methane, 1,1-bis(4-hydroxyphenyl)ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl)cyclohexane, bis(4-hydroxyphenyl sulfide), and 1,1-bis(4-hydroxy-t-butylphenyl) propane. Combinations comprising at least one of the foregoing dihydroxy compounds can also be used.

In another embodiment, the polysiloxane blocks are of formula (13)

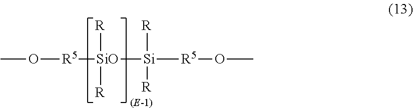

wherein R and E are as described above, and each R⁵ is independently a divalent C₁-C₃₀ organic group, and wherein the polymerized polysiloxane unit is the reaction residue of its corresponding dihydroxy compound. In a specific embodiment, the polysiloxane blocks are of formula (14):

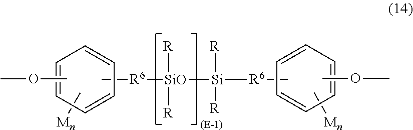

wherein R and E are as defined above. R⁶ in formula (14) is a divalent C₂-C₈ aliphatic group. Each M in formula (14) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkylaryl, or C₇-C₁₂ alkylaryloxy, wherein each n is independently 0, 1, 2, 3, or 4.

In an embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a combination of methyl and trifluoropropyl, or a combination of methyl and phenyl. In still another embodiment, M is methoxy, n is one, R² is a divalent C₁-C₃ aliphatic group, and R is methyl.

Blocks of formula (14) can be derived from the corresponding dihydroxy siloxane (15)

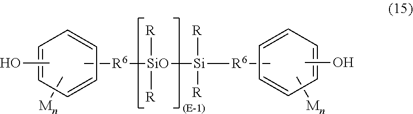

wherein R, E, M, R⁶, and n are as described above. Such dihydroxy polysiloxanes can be made by effecting a platinum-catalyzed addition between a siloxane hydride of formula (16)

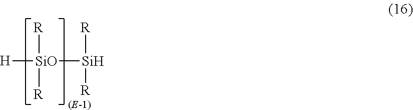

wherein R and E are as previously defined, and an aliphatically unsaturated monohydric phenol. Exemplary aliphatically unsaturated monohydric phenols include eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol. Combinations comprising at least one of the foregoing can also be used.

The poly(siloxane-carbonate) can comprise 50 to 99 weight percent of carbonate units and 1 to 50 weight percent siloxane units. Within this range, the poly(siloxane-carbonate)copolymer can comprise 70 to 98 weight percent, more specifically 75 to 97 weight percent of carbonate units and 2 to 30 weight percent, more specifically 3 to weight percent siloxane units.

Poly(siloxane-carbonate)s can have a weight average molecular weight of 2,000 to 100,000 Daltons, specifically 5,000 to 50,000 Daltons as measured by gel permeation chromatography using a crosslinked styrene-divinyl benzene column, at a sample concentration of 1 milligram per milliliter, and as calibrated with polycarbonate standards.

The thermoplastic composition can further include impact modifier(s). Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than about 10° C., more specifically less than about −10° C., or more specifically about −40° to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl (meth)acrylates; elastomeric copolymers of C₁₋₈ alkyl (meth)acrylates with butadiene and/or styrene; or combinations comprising at least one of the foregoing elastomers. materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate.

Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). If used, impact modifiers can be present in amounts of 1 to 30 wt %, based on the total weight of the polymers in the composition.

Flow promoters used in the thermoplastic are known in the art, and include pentaerythritol tetra benzoate (PETB), polybutylene terephthalate (PBT) cyclics, glycol-modified polyesters such as PCTG, fatty amides and imides of 8 to 35 carbon atoms, and hydrogenated terpene phenol resin. In an exemplary embodiment, the flow promoter is a fatty amide or imide of 8 to 35 carbon atoms, specifically a bis-imide or monounsaturated fatty imide of 18 to 35 carbon atoms, and more specifically, erucamide (13-docosenamide) or C₁₇H₃₅—C(O)—NH—CH₂—NH—C(O)—C₁₇H₃₅. The amount of flow promoter used in the thermoplastic composition will depend on the specific type used and the molding processing conditions. In an exemplary embodiment, the amount of flow promoter in the thermoplastic composition is from about 0.05 wt % to about 1 wt %, specifically from about 0.1 wt. % to about 0.5 wt. %, and more specifically from about 0.2 wt. % to about 5 wt. %. In other exemplary embodiments, the amount of flow promoter in the thermoplastic composition is from about 0.05 wt % to about 20 wt %, specifically from about 0.1 wt. % to about 10 wt. %, and more specifically from about 0.2 wt. % to about 5 wt. %.

In addition to the polycarbonate and flow promoter, the thermoplastic composition can include various additives ordinarily incorporated into polymer compositions of this type, with the proviso that the additive(s) are selected so as to not significantly adversely affect the desired properties of the thermoplastic composition. Such additives can be mixed at a suitable time during the mixing of the components for forming the composition. Exemplary additives include fillers, reinforcing agents, antioxidants, heat stabilizers, light stabilizers, ultraviolet (UV) light stabilizers, plasticizers, lubricants, mold release agents, antistatic agents, colorants such as such as titanium dioxide, carbon black, and organic dyes, surface effect additives, radiation stabilizers, flame retardants, and anti-drip agents. Combinations of additives can also be used, for example a combination of a heat stabilizer, mold release agent, and ultraviolet light stabilizer. In general, the additives are used in the amounts generally known to be effective. The total amount of additives (other than any impact modifier, filler, or reinforcing agents) is generally 0.01 to 5 wt. %, based on the total weight of the composition.

Plasticizers, lubricants, and/or mold release agents can also be used. There is considerable overlap among these types of materials, which include phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl) phosphate of hydroquinone and the bis(diphenyl) phosphate of bisphenol A; poly-alpha-olefins; epoxidized soybean oil; silicones, including silicone oils; esters, for example, fatty acid esters such as alkyl stearyl esters, e.g., methyl stearate, stearyl stearate, pentaerythritol tetrastearate, and the like; combinations of methyl stearate and hydrophilic and hydrophobic nonionic surfactants comprising polyethylene glycol polymers, polypropylene glycol polymers, poly(ethylene glycol-co-propylene glycol) copolymers, or a combination comprising at least one of the foregoing glycol polymers, e.g., methyl stearate and polyethylene-polypropylene glycol copolymer in a solvent; waxes such as beeswax, montan wax, and paraffin wax. Such materials are used in amounts of 0.1 to 1 parts by weight (pbw), based on 100 parts by weight of the total composition, excluding any filler.

The thermoplastic compositions can be manufactured by various methods. For example, powdered polycarbonate, flow promoting additive, and other additives such as a mold release agent are first blended, optionally with fillers in a HENSCHEL-Mixer* high speed mixer. Other low shear processes, including but not limited to hand mixing, can also accomplish this blending. The blend is then fed into the throat of a twin-screw extruder via a hopper. Alternatively, at least one of the components can be incorporated into the composition by feeding directly into the extruder at the throat and/or downstream through a sidestuffer. Additives can also be compounded into a masterbatch with a desired polymeric resin and fed into the extruder. The extruder is generally operated at a temperature higher than that necessary to cause the composition to flow. The extrudate is immediately quenched in a water batch and pelletized. The pellets, so prepared, when cutting the extrudate can be one-fourth inch long or less as desired. Such pellets can be used for subsequent molding, shaping, or forming.

Transparent compositions can be produced by manipulation of the process used to manufacture the polycarbonate composition. One example of such a process to produce transparent polycarbonate compositions is described in U.S. Patent Application No. 2003/0032725.

The polycarbonate compositions can further have a Notched Izod Impact (NII) of at least about 20 Joules per meter (J/m), more specifically at least about 25 J/m, measured at 23° C. using ⅛-inch thick bars (3.18 mm) in accordance with ASTM D256, as well as enhanced surface impact properties.

In the embodiments described herein, the hard coat comprises a hard coat composition that has a hardness after cure that provides a hardness to the over-coated article so as to achieve a pencil hardness of at least 5H according to JIS K5400, more specifically of at least 6H, and even more specifically of at least 7H. In exemplary embodiments, hard coats are also transparent and colorless, and in other exemplary embodiments, can protect the underlying coated article from exposure to ultraviolet radiation. Hard coats are generally thermosetting, but may be thermoformable or non-thermoformable. Typically, a non-thermoformable hard coat is applied after the article to be hard coated has been shaped to its final shape, whereas a thermoformable hard coat may be applied prior to shaping (e.g., thermoforming, etc.) by coextruding, coating, or other suitable methods, and is subsequently cured to its desired final hardness during or after shaping to form the article. Hard coats may be a single layer of hard coat having sufficient scratch resistance. The selection of the specific hard coat to provide the requisite hardness is within the skill of the art. Generally, hard coats comprise curable (i.e., cross-linkable) polymers, and may be based on hydroxy-containing organic polymers such as novolacs, organosilicon polymers such as polysilsesquioxane copolymers, acrylates, or a combination comprising at least one of the foregoing.

Organosiloxane polymers useful as silicone-based hard coats comprise the structure:

MₐD_{b}T_{c}Q_{d},

wherein the subscripts a, b, c, and d are zero or a positive integer, subject to the limitation that if subscripts a and b are both equal to zero, subscript c is greater than or equal to two; M has the formula R₉SiO_{1/2}; D has the formula R₁₀SiO_{2/2}; T has the formula R₁₁SiO_{3/2}; and Q has the formula SiO_{4/2}, wherein R₉, R₁₀, and R₁₁ each independently represents hydrogen, C₁₋₁₂ alkyl, C₂₋₁₂ alkenyl, C₆₋₁₂ aryl, or C₇₋₁₂ aralkyl. Exemplary alkenyl R-groups include vinyl, allyl, butenyl, pentenyl, hexenyl, and heptenyl, with vinyl being particularly useful. The alkenyl group can be bonded at the molecular chain terminals, in pendant positions on the molecular chain, or both. Other exemplary R groups include alkyl groups such as methyl, ethyl, propyl, butyl, pentyl, and hexyl; aryl groups such as phenyl, tolyl, and xylyl; aralkyl groups such as benzyl and phenethyl; reactive alkyl groups including epoxy end-capped alkyl or cycloalkyl groups such as glycidoxypropyl and (3,4-epoxycyclohexyl)ethyl groups and the like, alkoxysilane-terminated groups such as trialkoxysilylethyl, alkyldialkoxysilylethyl, and the like, as derived from, for example, monomers including glycidoxypropyl trialkoxysilane, glycidoxypropyl dialkoxy alkyl silane, 2,3-epoxycyclohexyl-4-ethyl trialkoxysilane, 2,3-epoxycyclohexyl-4-ethoxyethyl dialkoxyalkylsilane, or a combination comprising at least one of the foregoing alkoxysilane monomers, or (meth)acrylate terminated alkyl groups such as those derived from trialkoxysilylpropyl(meth)acrylates; and halogenated alkyl groups such as 3-chloropropyl and 3,3,3-trifluoropropyl. Methyl and phenyl are specifically useful.

Where at least one organosiloxane polymer is used, the organosiloxane polymer can comprise silanol end groups that are curable in the presence of moisture and an acid or base catalyst. In another embodiment, at least one organosiloxane polymer is used, wherein the organosiloxane polymer comprises one or more reactive groups such as epoxy or (meth)acrylate. Where the reactive groups comprise epoxy groups, the organosiloxane polymer may be cured to form a crosslinked network using dihydroxy organic compounds comprising at least two aromatic hydroxy groups, such as for example, resorcinol, bisphenol-A, or the like.

Alternatively, the hard coat composition comprises a curable hydroxy-containing organic polymer containing hydroxy aromatic groups such as a novolac or a resole polymer. Such polymers can be derived from phenol and/or a singly or multiply C₁₋₁₂ alkyl substituted phenol and an aldehyde such as formaldehyde, acetaldehyde, hexanal, octanal, dodecanal, or the like. The hydroxy-containing organic polymer may be derived from a hydroxystyrene-based polymer such as polyhydroxystyrene. The hydroxy-containing organic polymer may be substituted with reactive, i.e., crosslinkable groups such as epoxy groups. In a specific embodiment, the hydroxy-containing organic polymer is a novolac, an epoxy-substituted novolac, or a combination comprising at least one of the foregoing novolacs. In still another embodiment a carboxylic-acid based polymer may be used, such as poly(meth)acrylic acid-containing polymers, where the carboxylic acid containing polymer is used to crosslink with an epoxy-containing polymer.

In another embodiment, a combination of two polymers is used, wherein least 2 of the R groups in a first organosiloxane polymer are alkenyl groups, and at least 2 of the R groups in a second organosiloxane polymer are hydrogen groups (i.e., silicon hydride groups). The alkenyl-containing organopolysiloxane can have straight chain, partially branched straight chain, branched-chain, or network molecular structure, or may be a mixture of such structures. The alkenyl-containing organopolysiloxane is exemplified by trimethylsiloxy-endblocked dimethylsiloxane-methylvinylsiloxane copolymers; trimethylsiloxy-endblocked methylvinylsiloxane-methylphenylsiloxane copolymers; trimethylsiloxy-endblocked dimethylsiloxane-methylvinylsiloxane-methylphenylsiloxane copolymers; dimethylvinylsiloxy-endblocked dimethylpolysiloxanes; dimethylvinylsiloxy-endblocked methylvinylpolysiloxanes; dimethylvinylsiloxy-endblocked methylvinylphenylsiloxanes; dimethylvinylsiloxy-endblocked dimethylvinylsiloxane-methylvinylsiloxane copolymers; dimethylvinylsiloxy-endblocked dimethylsiloxane-methylphenylsiloxane copolymers; dimethylvinylsiloxy-endblocked dimethylsiloxane-diphenylsiloxane copolymers; and mixtures comprising at least one of the foregoing organopolysiloxanes.

The hydrogen-containing organopolysiloxane is exemplified by trimethylsiloxy-endblocked methylhydrogenpolysiloxanes; trimethylsiloxy-endblocked dimethylsiloxane-methylhydrogensiloxane copolymers; trimethylsiloxy-endblocked methylhydrogensiloxane-methylphenylsiloxane copolymers; trimethylsiloxy-endblocked dimethylsiloxane-methylhydrogensiloxane-methylphenylsiloxane copolymers; dimethylhydrogensiloxy-endblocked dimethylpolysiloxanes; dimethylhydrogensiloxy-endblocked methylhydrogenpolysiloxanes; dimethylhydrogensiloxy-endblocked dimethylsiloxanes-methylhydrogensiloxane copolymers; dimethylhydrogensiloxy-endblocked dimethylsiloxane-methylphenylsiloxane copolymers; and dimethylhydrogensiloxy-endblocked methylphenylpolysiloxanes.

The hydrogen-containing organopolysiloxane component is used in an amount sufficient to cure the composition, specifically in a quantity that provides from about 1.0 to about 10 silicon-bonded hydrogen atoms per alkenyl group in the alkenyl-containing organopolysiloxane.

Where a combination of organosiloxane polymers, one having alkenyl groups and a second having hydrogen groups is used, the hard coat further comprises, generally as a component of the part containing the organopolysiloxane having at least two alkenyl groups per molecule, a hydrosilylation-reaction catalyst. Effective catalysts promote the addition of silicon-bonded hydrogen onto alkenyl multiple bonds to accelerate the cure. Such catalyst can include a noble metal, such as, for example, platinum, rhodium, palladium, ruthenium, iridium, or a combination comprising at least one of the foregoing. The catalyst can also include a support material, specifically activated carbon, aluminum oxide, silicon dioxide, thermoplastic resin, and combinations comprising at least one of the foregoing.

Platinum and platinum compounds known as hydrosilylation-reaction catalysts are preferred, and include, for example platinum black, platinum-on-alumina powder, platinum-on-silica powder, platinum-on-carbon powder, chloroplatinic acid, alcohol solutions of chloroplatinic acid, platinum-olefin complexes, platinum-alkenylsiloxane complexes and the catalysts afforded by the microparticulation of the dispersion of a platinum addition-reaction catalyst, as described above, in a thermoplastic resin such as methyl methacrylate, polycarbonate, polystyrene, silicone, and the like. Mixtures of catalysts may also be used. A quantity of catalyst effective to cure the present composition is used, generally from about 0.1 to about 1,000 parts per million by weight (ppm) of metal (e.g., platinum) based on the combined amounts of the reactive organopolysiloxane components.

Other additives may be included in the coating composition may be included to add or enhance the properties of the hard coat. For example, filler may be used to increase hardness. A specifically useful hard coat filler is a silica filler, which has good dispersibility in the hard coat composition. The silica is desirably of an average particle size of about 10 nm to 100 μm, and may be untreated, or treated with for example, a silane adhesion promoter. Where used, a filler is used in the hard coat in an amount of 0.1 to 50 wt % of the total weight of the organosiloxane polymer. Other additives include: methyl vinyl cycloalkyl cure retardants which bind the platinum at room temperature to prevent early cure, but release the platinum at higher temperatures to affect cure; ultraviolet absorbers (UVA's) such as, for example, benzotriazoles and hydroxybenzophenones, silylated UVA's such as 4,6-dibenzoyl-2-(trialkoxysilylalkyl) resorcinols (such as described in U.S. Pat. No. 5,391,795 to Pickett) and 4-(γ-triethoxysilane)propoxy-2-hydroxybenzophenone (such as those described in U.S. Pat. No. 4,373,061 to Ching). UV absorbers, where used, may be included in the composition used to form the UV absorbing layer in an amount of 0.2 to 10 wt %, based on the total weight of the coating composition. In another embodiment, a coating composition is a UV absorbing layer comprising polycarbonate, and additional polymer such as, for example, PCCD. Additives, where used, may be present in an amount of 0.1 to 20 wt %, based on the total weight of the polymer.

The hard coat composition can further comprise a solvent, such as water, or a branched or straight chain C₁₋₁₂ alcohol, ether alcohol, diol, polyol, or ether-acetate, or other C₁₋₁₂ organic solvent miscible with these alcohols.

Once coated, the hard coat layer is dried to form the uncured hard coat, and can be cured thermally, or by photo initiation wherein the hard coat composition comprises a photolytic cure catalyst and curable groups reactive with the cure catalyst.

The hard coat can also comprise a primer layer which is disposed on the article to be coated prior to the hard coat layer. Useful primer layers include those based on copolymers comprising C₁₋₁₂ alkyl (meth)acrylates, (meth)acrylic acid, substituted methacrylates such as hydroxyalkyl (meth)acrylates, silane substituted methacrylates including alkoxysilane substituted methacrylates, epoxy-substituted methacrylates, and the like. Other non-(meth)acrylate monomers co-polymerizable with the (meth)acrylate monomers including styrenes, C₁₋₁₂ olefins, C₁₋₁₂ vinyl ethers, C₁₋₁₂ (meth)acrylamides, meth(acrylonitrile), and the like.

Exemplary curable (thermosetting) hard coats comprising a hard coat layer and a primer layer include thermally curable silicone hard coat systems Some useful hard coats may have a high crosslink density. Hard coats may be curable by UV, heat, or both UV and heat. Useful hard coats include UVHC7800 from Momentive Performance Materials Inc., and Hard Coat for acryl 9H, from Taiseplas Co. Ltd. Other exemplary hard coats can be prepared according to the compositions and methods described in U.S. Pat. No. 5,679,820, the disclosure of which is incorporated herein by reference.

In another embodiment requiring additional scratch resistance with the ability to thermoform after hard coating, thermoformable hard coat systems can be used. An example of a thermoformable phenolic hard coat is FMR Clear Coat AEG21153 from Red Spot Paint and Varnish Company. Sheet or film prepared with a coating such as the FMR coating can be thermoformed as described above to give the desired window shape without damaging the hard coat. Other exemplary thermoformable hard coats Examples of suitable thermoformable hard coats can be prepared according to the compositions and methods described in U.S. Pat. No. 6,350,521, the disclosure of which is incorporated herein by reference.

In an embodiment, the thermoplastic composition is used to prepare a window article. As used herein, a “window article” comprises a frame, and a sheet supported by the frame. Also as disclosed herein, “sheet” can mean a shaped or unshaped sheet, and may further mean a molded or extruded article of substantially uniform thickness and which is unshaped or is further shaped. Also as disclosed herein, “supported by” means wherein the window article is in contact with and is fixed or movable with respect to the frame, and where the frame can be fixed or movable with respect to a surrounding element, such that the frame is intervening between the window article and surrounding element, and the sheet does not directly contact the surrounding element. In an embodiment, a window comprises the window article. In an embodiment, window articles can be a component of an electronic device such as a portable electronic device, e.g., mobile phone, gaming system, media player, etc. Other shaped, formed, or molded articles comprising the thermoplastic compositions are also provided. The polycarbonate compositions can be molded into useful shaped articles by a variety of means such as injection molding, extrusion, rotational molding, blow molding and thermoforming to form articles such as, for example, computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. In addition, the polycarbonate compositions are particularly well-suited for use in applications such as electronic device display screen cover, electronic device touch screen, or electronic device keypad, in particular for portable electronic devices where properties such as scratch, mar, and impact resistance are desired.

### EXAMPLES OF EMBODIMENTS

In one embodiment, a plastic article comprises:

a substantially transparent substrate having a thickness of from 0.2 mm to 3.0 mm, and comprising a thermoplastic composition comprising a polycarbonate and having a melt flow index as defined by ASTM D1238 of 10 g/10 min. to 50 g/10 min. at 300° C. and a 1.2 kg load, said thermoplastic composition comprising 20 mol % to 80 mol % of carbonate units represented by the formula (I)

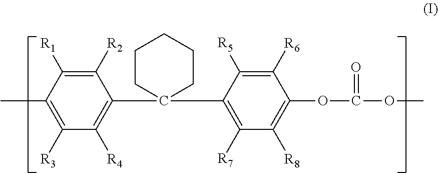

wherein R₁, R₂, R₃, R₄, R₅, R₆, R₇, and R₈ each independently represents hydrogen or C₁₋₆ alkyl, and 80 mol % to 20 mol % of one or more other carbonate units, represented by the formula (II)

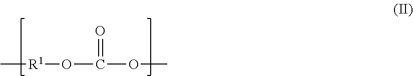

wherein at least 60 percent of the total number of R¹ groups contain aromatic moieties and the balance thereof are aliphatic, alicyclic, or aromatic, wherein said mol % values are based on the total number of carbonate units in the polymer composition; and

a hard coat disposed over a surface of said transparent substrate, said hard coat providing said article with a pencil hardness of at least 5H as determined according to JIS K5400 using a 0.75 kilograms force (kgf) load.

In another embodiment, a plastic article comprises:

a substantially transparent substrate having a thickness of from 0.2 mm to 1.5 mm, and comprising a thermoplastic composition comprising a polycarbonate and a flow promoting additive, and having a melt flow index as defined by ASTM D1238 of 10 g/10 min. to 50 g/10 min. at 300° C. and a 1.2 kg load, said thermoplastic composition comprising 20 mol % to 80 mol % of carbonate units represented by the formula (I)

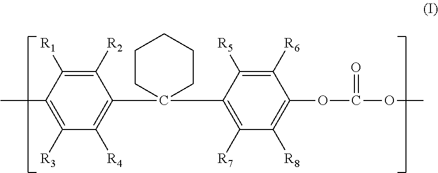

wherein R₁, R₂, R₃, R₄, R₅, R₆, R₇, and R₈ each independently represents hydrogen or C₁₋₆ alkyl, and 80 mol % to 20 mol % of one or more other carbonate units, represented by the formula (II)

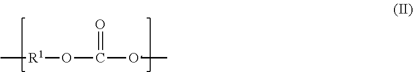

wherein at least 60 percent of the total number of R¹ groups contain aromatic moieties and the balance thereof are aliphatic, alicyclic, or aromatic, wherein said mol % values are based on the total number of carbonate units in the polymer composition; and

a hard coat disposed over a surface of said transparent substrate, said hard coat providing said article with a pencil hardness of at least 5H as determined according to JIS K5400 using a 0.75 kgf load.

In the various embodiments, (i) the thermoplastic composition further comprises a flow promoting additive in an amount of 0.05 to 1 wt. %, based on the weight of the thermoplastic composition; and/or (ii) the flow promoting additive is a fatty amide or imide compound having from 8 to 35 carbon atoms; and/or the flow promoting additive is a bis-imide or a monounsaturated fatty amide having from 18 to 35 carbon atoms; and/or the flow promoting additive is erucamide or C₁₇H₃₅—C(O)—NH—CH₂—NH—C(O)—C₁₇H₃₅; and/or (iii) the units of formula (II) are not within the scope of formula (I); and/or (iv) the thermoplastic composition comprises a plurality of different carbonate units with the scope of formula (I), a plurality of different carbonate units with the scope of formula (II), or a plurality of different carbonate units with the scope of formula (I) and a plurality of different carbonate units with the scope of formula (II); and/or (v) the thermoplastic composition comprises a first polycarbonate comprising units of formula (I) and optionally units of formula (II), and a second polycarbonate comprising units of formula (II); and/or the hard coat provides the article with a pencil hardness of at least 6H; and/or (vi) the hard coat provides the article with a pencil hardness of at least 7H; and/or (vii) the thermoplastic composition comprises from 30 mol % to 80 mol % of units represented by formula (I) and from 70 mol % to 20 mol % of one or more units represented by formula (II); and/or (viii) the thermoplastic composition comprises from 40 mol % to 80 mol % of units represented by formula (I) and from 60 mol % to 20 mol % of one or more units represented by formula (II); and/or (ix) the thermoplastic composition has a melt flow index of 14 g/10 min. to 50 g/10 min; and/or (x) the thermoplastic composition has a melt flow index of 20 g/10 min. to 50 g/10 min; and/or (xi) the substrate has a thickness of 0.5 mm to 1.3 mm; and/or (xii) the cured hard coat has a thickness of 10 μm to 50 μm; and/or (xiii) the cured hard coat has a thickness of 14 μm to 40 μm; and/or (xiv) the article has a light transmittance of at least 85% according to ASTM D 1003; and/or (xv) the article has a light transmittance of at least 87%; and/or (xvi) the article has a light transmittance of at least 89%; and/or (xvii) the article has a haze no greater than 4 according to ASTM D 1003; and/or (xviii) the article has a haze no greater than 3; and/or (xvii) the article has a haze no greater than 1; and/or (xix) R₁ and R₆ are each methyl; and/or (xxi) R₁-R₆ each represents hydrogen; and/or (xxii) the article is an electronic device display screen cover, electronic device touch screen, or electronic device keypad; and/or (xxiii) the electronic device is a mobile phone or a portable media player; (xxiv) the flow promoting additive in an amount of 0.1 to 0.5 wt. %, based on the weight of the thermoplastic composition; (xxv) a method of making the article comprises injection molding the thermoplastic composition to form the substantially transparent substrate, applying a layer of a hard-coat coating composition to a surface of said transparent sheet; and curing said coating composition to form the hard coat; and/or (xxvi) the hard coat coating composition is cured with ultraviolet radiation; and/or (xxvii) the hard coat coating composition is cured with heat; and/or the hard coat coating composition is cured with ultraviolet radiation and heat.

The thermoplastic composition is further illustrated by the following non-limiting examples.

### EXAMPLES

The parts by weight of raw materials set forth in Table 1 below were mixed and melt-extruded to obtain pellets of Resin 1 and Resin 2.

TABLE 1

| | Resin 1 | Resin 2 |
|---|---|---|
| DMBPC-BPA co-PC (50:50 molar ratio, | 100 | 100 |
| MW = 23300 | | |
| Pentaerythritol tetrastearate | 0.4 | 0.4 |
| Tris(2,4-di-t-butylphenyl)phosphite | 0.1 | 0.1 |
| Erucamide (13-dodosenamide) | | 0.2 |

The pellets were injection molded into plates having dimensions of 256 mm×182 mm×1 mm using a Nissei Plastics Industrial FN7000 injection molding machine under molding conditions as set forth in Table 2 below:

TABLE 2

| | Substrate 1 | Substrate 2 | Substrate 3 | Substrate 4 |
|---|---|---|---|---|
| Molded pellets | Resin 1 | Resin 2 | HF1810 | 121R |
| Barrel Set | | | | |
| Temperature | | | | |
| (° C.) | | | | |
| Nozzle | 345 | 320 | 305 | 335 |
| H1 | 345 | 320 | 310 | 335 |
| H2 | 300 | 300 | 270 | 300 |
| H3 | 260 | 280 | 260 | 260 |
| Screw speed | 82 | 83 | 82 | 82 |
| (rpm) | | | | |
| Mold | 90 | 90 | 90 | 90 |
| Temperature | | | | |
| (° C.) | | | | |

Resin 1: Table 1 above, MFI = 14 g/10 min., measured at 300° C. under 1.2 kg load.
Resin 2: Table 1 above, MFI = 24 g/10 min., measured at 300° C. under 1.2 kg load.
HF1810: LEXAN ® HFD1810 (comparative example) available commercially from SABIC Innovative Plastics, MFR = 42 g/10 min., measured at 300° C. under 1.2 kg load.
121R: LEXAN ® 121R (comparative example) available commercially from SABIC Innovative Plastics, MFI = 18.5 g/10 min., measured at 300° C. under 1.2 kg load.

Samples of each of the substrates 1 to 4 were coated with the following hard coat coating, applied by spray coating, followed by drying and UV curing:
Hard Coat 1: UVHC7800, commercially available from Momentive Performance Materials Inc.
Hard Coat 2: Hard Coat for acryl 9H, supplied by Taiseplas Co. Ltd.
Hard Coat 3: UV840, commercially available from Musashi Paint Co., Ltd.

The thickness of the hard coat layer on the substrate was measured by cutting the coated substrate perpendicularly with a microtome and observing the cross-sectional cut surface with a scanning electron microscope (Hitachi model S-3000N) to determine the thickness of the hard coat layer. Pencil hardness was measured according to JIS K400 at 23° C. under 0.75 kgf using Mitsubishi Hi-uni pencils. Light transmittance and haze of the coated substrates was measured according to JIS K7361-1. Yellowness index (YI) was measured according to JIS K7105. The results are set forth in Table 3 below:

TABLE 3

| | | | Hard coat | | | | |
|---|---|---|---|---|---|---|---|
| | | Coating | layer | Pencil | Total | | |
| | Substrate | Material | thickness (μm) | Hardness | transmittance | Haze | YI |
| Ex. 1 | Substrate 1 | Hard Coat 1 | 25.6 | 7H | 89.6 | 0.6 | 1.0380 |
| Ex. 2 | Substrate 1 | Hard Coat 2 | 18.7 | 7H | 89.3 | 3.1 | 1.0940 |
| Ex. 3 | Substrate 2 | Hard Coat 1 | 26.7 | 5H | 90.2 | 0.6 | 1.7170 |
| Ex. 4 | Substrate 2 | Hard Coat 2 | 19.0 | 6H | 90.0 | 2.4 | 1.7790 |
| C. Ex 1 | Substrate 1 | Hard Coat 3 | not measured | 3H | 89.4 | 0.6 | 1.0350 |
| C. Ex. 2 | Substrate 2 | Hard Coat 3 | not measured | 3H | 90 | 0.7 | 1.5980 |
| C. Ex. 3 | Substrate 3 | Hard Coat 1 | 26.3 | 3H | 90.2 | 0.3 | 0.7030 |
| C. Ex. 4 | Substrate 3 | Hard Coat 2 | 18.3 | H | 89.9 | 1.9 | 0.8960 |
| C. Ex. 5 | Substrate 3 | Hard Coat 3 | not measured | F | 89.9 | 0.4 | 0.6960 |
| C. Ex. 6 | Substrate 4 | Hard Coat 1 | 26.0 | 3H | 90.8 | 0.4 | 1.1520 |
| C. Ex. 7 | Substrate 4 | Hard Coat 2 | 18.2 | H | 90.5 | 2.4 | 1.1830 |
| C. Ex. 8 | Substrate 4 | Hard Coat 3 | not measured | F | 90.4 | 0.3 | 1.0660 |
| C. Ex. 9 | Substrate 1 | — | — | H | — | — | — |
| C. Ex. | Substrate 2 | — | — | H | — | — | — |
| 10 | | | | | | | |
| C. Ex. | Substrate 3 | — | — | 4B | — | — | — |
| 11 | | | | | | | |
| C. Ex. | Substrate 4 | — | — | 2B | — | — | — |
| 12 | | | | | | | |

The data in Table 3 demonstrate that the materials of the invention exhibit superior pencil hardness while maintaining high transmittance, low haze, and low yellowness, versus the comparative examples.

The singular forms “a,” “an,” and “the” include plural referents unless the context clearly dictates otherwise.

Unless defined otherwise, technical and scientific terms used herein have the same meaning as is commonly understood by one of skill in the art to which this invention belongs.

The modifier “about” used in connection with a quantity is inclusive of the stated value and has the meaning dictated by the context (e.g., includes the degree of error associated with measurement of the particular quantity).

The notation “±10%” means that the indicated measurement can be from an amount that is minus 10% to an amount that is plus 10% of the stated value.

The terms “front”, “back”, “bottom”, and/or “top” are used herein, unless otherwise noted, merely for convenience of description, and are not limited to any one position or spatial orientation.

The endpoints of all ranges directed to the same component or property are inclusive and independently combinable (e.g., ranges of “less than or equal to about 25 wt %, or, more specifically, about 5 wt % to about 20 wt %,” is inclusive of the endpoints and all intermediate values of the ranges of “about 5 wt % to about 25 wt %,” etc.).

The suffix “(s)” as used herein is intended to include both the singular and the plural of the term that it modifies, thereby including at least one of that term (e.g., the colorant(s) includes at least one colorants).

As used herein, the term “(meth)acrylate” encompasses both acrylate and methacrylate groups.

“Optional” or “optionally” means that the subsequently described event or circumstance can or cannot occur, and that the description includes instances where the event occurs and instances where it does not.

Compounds are described using standard nomenclature. For example, any position not substituted by any indicated group is understood to have its valency filled by a bond as indicated, or a hydrogen atom. A dash (“−”) that is not between two letters or symbols is used to indicate a point of attachment for a substituent. For example, —CHO is attached through carbon of the carbonyl group.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

As used herein, the term “hydrocarbyl” refers broadly to a substituent comprising carbon and hydrogen, optionally with 1 to 3 heteroatoms, for example, oxygen, nitrogen, halogen, silicon, or sulfur; “alkyl” refers to a straight or branched chain monovalent hydrocarbon group; “alkylene” refers to a straight or branched chain divalent hydrocarbon group; “alkylidene” refers to a straight or branched chain divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound.

Exemplary groups that can be present on a “substituted” position include, but are not limited to, halogen; cyano; hydroxyl; nitro; azido; alkanoyl (such as a C2-C6 alkanoyl group such as acyl or the like); carboxamido; alkyl groups (typically having 1 to about 8 carbon atoms, or 1 to about 6 carbon atoms); cycloalkyl groups, alkenyl and alkynyl groups (including groups having at least one unsaturated linkages and from 2 to about 8, or 2 to about 6 carbon atoms); alkoxy groups having at least one oxygen linkages and from 1 to about 8, or from 1 to about 6 carbon atoms; aryloxy such as phenoxy; alkylthio groups including those having at least one thioether linkages and from 1 to about 8 carbon atoms, or from 1 to about 6 carbon atoms; alkylsulfinyl groups including those having at least one sulfinyl linkages and from 1 to about 8 carbon atoms, or from 1 to about 6 carbon atoms; alkylsulfonyl groups including those having at least one sulfonyl linkages and from 1 to about 8 carbon atoms, or from 1 to about 6 carbon atoms; aminoalkyl groups including groups having at least one N atoms and from 1 to about 8, or from 1 to about 6 carbon atoms; aryl having 6 or more carbons and at least one rings, (e.g., phenyl, biphenyl, naphthyl, or the like, each ring either substituted or unsubstituted aromatic); arylalkyl having 1 to 3 separate or fused rings and from 6 to about 18 ring carbon atoms, with benzyl being an exemplary arylalkyl group; or arylalkoxy having 1 to 3 separate or fused rings and from 6 to about 18 ring carbon atoms, with benzyloxy being an exemplary arylalkoxy group.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A plastic article, comprising
a substantially transparent substrate having a thickness of from 0.2 mm to 3.0 mm, and comprising a thermoplastic composition comprising a polycarbonate and having a melt flow index as defined by ASTM D1238 of 10 g/10 min. to 50 g/10 min. at 300° C. and a 1.2 kg load, said thermoplastic composition comprising 20 mol % to 80 mol % of carbonate units represented by the formula (I) 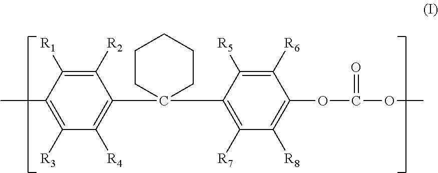
wherein R₁, R₂, R₃, R₄, R₅, R₆, R₇, and R₈ each independently represents hydrogen or C₁₋₆ alkyl, and 80 mol % to 20 mol % of carbonate units represented by the formula (II) 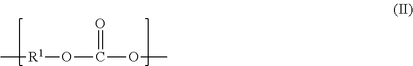
wherein at least 60 percent of the total number of R¹ groups contain aromatic moieties and the balance thereof are aliphatic, alicyclic, or aromatic, wherein said mol % values are based on the total number of carbonate units in the polymer composition; and
a hard coat disposed over a surface of said transparent substrate, said hard coat providing said article with a pencil hardness of at least 5H as determined according to JIS K5400 using a 0.75 kgf load.

2. The article of claim 1, wherein the thermoplastic composition further comprises a flow promoting additive in an amount of 0.05 to 1 wt. %, based on the weight of the thermoplastic composition.

3. The article of claim 2, wherein said flow promoting additive is a fatty amide or imide compound having from 8 to 35 carbon atoms.

4. The article of claim 3, wherein said flow promoting additive is a bis-imide or a monounsaturated fatty amide having from 18 to 35 carbon atoms.

5. The article of claim 4, wherein said flow promoting additive is erucamide or C₁₇H₃₅—C(O)—NH—CH₂—NH—C(O)—C₁₇H₃₅.

6. The article of claim 1, wherein the units of formula (II) are not within the scope of formula (I).

7. The article of claim 1, wherein the thermoplastic composition comprises a plurality of different carbonate units with the scope of formula (I), a plurality of different carbonate units with the scope of formula (II), or a plurality of different carbonate units with the scope of formula (I) and a plurality of different carbonate units with the scope of formula (II).

8. The article of claim 1, wherein said thermoplastic composition comprises a first polycarbonate comprising units of formula (I) and optionally units of formula (II), and a second polycarbonate comprising units of formula (II).

9. The article of claim 1, wherein said hard coat provides the article with a pencil hardness of at least 6H.

10. The article of claim 9, wherein said hard coat provides the article with a pencil hardness of at least 7H.

11. The article of claim 1, wherein said thermoplastic composition comprises from 30 mol % to 80 mol % of units represented by formula (I) and from 70 mol % to 20 mol % of one or more units represented by formula (II).

12. The article of claim 11, wherein said thermoplastic composition comprises from 40 mol % to 80 mol % of units represented by formula (I) and from 60 mol % to 20 mol % of one or more units represented by formula (II).

13. The article of claim 1, wherein said thermoplastic composition has a melt flow index of 14 g/10 min. to 50 g/10 min.

14. The article of claim 13, wherein said thermoplastic composition has a melt flow index of 20 g/10 min. to 50 g/10 min.

15. The article of claim 1, wherein said substrate has a thickness of 0.5 mm to 1.5 mm.

16. The article of claim 1, wherein the cured hard coat has a thickness of 10 μm to 50 μm.

17. The article of claim 16, wherein the cured hard coat has a thickness of 14 μm to 40 μm.

18. The article of claim 1, wherein the article has a light transmittance of at least 85% according to ASTM D 1003.

19. The article of claim 18, wherein the article has a light transmittance of at least 87%.

20. The article of claim 19, wherein the article has a light transmittance of at least 89%.

21. The article of claim 1, wherein the article has a haze no greater than 4 according to ASTM D 1003.

22. The article of claim 21, wherein the article has a haze no greater than 3.

23. The article of claim 22, wherein the article has a haze no greater than 1.

24. The article of claim 1, wherein R₁ and R₆ are each methyl.

25. The article of claim 1, wherein R₁-R₆ each represents hydrogen.

26. The article of claim 1 that is an electronic device display screen cover, electronic device touch screen, or electronic device keypad.

27. The article of claim 26, wherein the electronic device is a mobile phone or a portable media player.

28. A plastic article, comprising
a substantially transparent substrate having a thickness of from 0.2 mm to 1.5 mm, and comprising a thermoplastic composition comprising a polycarbonate and a flow promoting additive, and having a melt flow index as defined by ASTM D1238 of 10 g/10 min. to 50 g/10 min. at 300° C. and a 1.2 kg load, said thermoplastic composition comprising 20 mol % to 80 mol % of carbonate units represented by the formula (I) 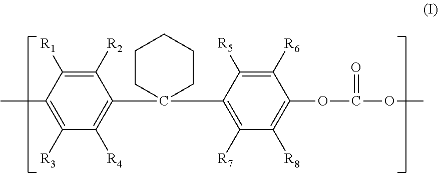
wherein R₁, R₂, R₃, R₄, R₅, R₆, R₇, and R₈ each independently represents hydrogen or C₁₋₆ alkyl, and 80 mol % to 20 mol % of carbonate units represented by the formula (II) 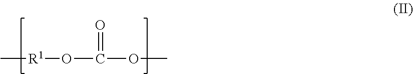
wherein at least 60 percent of the total number of R¹ groups contain aromatic moieties and the balance thereof are aliphatic, alicyclic, or aromatic, wherein said mol % values are based on the total number of carbonate units in the polymer composition; and
a hard coat disposed over a surface of said transparent substrate, said hard coat providing said article with a pencil hardness of at least 5H as determined according to JIS K5400 using a 0.75 kgf load.

29. The article of claim 28, wherein the flow promoting additive in an amount of 0.05 to 1 wt %, based on the weight of the thermoplastic composition.

30. The article of claim 29, wherein the flow promoting additive in an amount of 0.1 to 0.05 wt %, based on the weight of the thermoplastic composition.

31. The article of claim 28, wherein said flow promoting additive is a fatty amide or imide compound having from 8 to 35 carbon atoms.

32. The article of claim 31, wherein said flow promoting additive is a bis-imide or a monounsaturated fatty amide having from 18 to 35 carbon atoms.

33. The article of claim 32, wherein said flow promoting additive is erucamide or C₁₇H₃₅—C(O)—NH—CH₂—NH—C(O)—C₁₇H₃₅.

34. A method of making the article of claim 1, comprising:
injection molding the thermoplastic composition to form the substantially transparent substrate;
applying a layer of a hard-coat coating composition to a surface of said transparent sheet; and
curing said coating composition to form the hard coat.

35. The method of claim 34, wherein the coating composition is cured with ultraviolet radiation.

36. The method of claim 34, wherein the coating composition is cured with heat.

37. The method of claim 34, wherein the coating composition is cured with ultraviolet radiation and heat.

38. The method of claim 34, wherein the thermoplastic composition further comprises a flow promoting additive in an amount of 0.05 to 1 wt. %, based on the weight of the thermoplastic composition.

39. The method of claim 38, wherein said flow promoting additive is a bis-imide or a monounsaturated fatty amide having from 18 to 35 carbon atoms.

40. The method of claim 34, wherein the units of formula (II) are not within the scope of formula (I).

41. The method of claim 34, wherein said hard coat provides the article with a pencil hardness of at least 6H.

42. The method of claim 41, wherein said hard coat provides the article with a pencil hardness of at least 7H.

43. The method of claim 34, wherein the article has a light transmittance of at least 85% according to ASTM D 1003.
